(19) United States
(12) Patent Application Publication
(10) Pub. No.: US 2026/0230882 A1
(43) Pub. Date: Aug. 6, 2026

(54) Approaches for Delay Spread Management

(71) Applicant: Telefonaktiebolaget LM Ericsson (publ), Stockholm (SE)

(72) Inventors: Yueyu Wang, Karlstad (SE); Ming Li, Stockholm (SE)

(21) Appl. No.: 19/127,768

(22) PCT Filed: Nov. 8, 2022
(86) PCT No.: PCT/SE2022/051038

§ 371 Date: May 7, 2025

(51) Int. Cl. H04W 24/10; H04B 7/06; H04W 72/21; H04W 72/51; H04W 76/20

(52) U.S. Cl. CPC H04W 24/10; H04B 7/0626; H04W 72/21; H04W 72/51; H04W 76/20

(57) ABSTRACT

A method (200) for delay spread management is disclosed; performed by a radio access node configured to communicate with a user device. The method comprises transmitting (220) control signaling to the user device, wherein the control signaling is indicative of a configuration of the user device to perform delay spread measurements, and receiving (270) on or more delay spread report from the user device in response to the configuration. A corresponding method for delay spread management is also disclosed; performed by a user device configured to communicate with a radio access node. The method comprises performing delay spready measurements according to a configuration indicated by control signaling received from the radio access node, and transmitting one or more delay spread report indicative of a result of the delay spread measurements to the radio access node. In some embodiments, the method further comprises receiving the control signaling from the radio access node, wherein the control signaling is indicative of the configuration of the user device to perform delay spread measurements. Corresponding computer program product, apparatuses, radio access node, and user device are also disclosed.

### TECHNICAL FIELD

The present disclosure relates generally to the field of wireless communication. More particularly, it relates to methods, computer program product, apparatuses, radio access node, and user device for management of delay spread in wireless communication scenarios.

### BACKGROUND

Delay spread is a well-known phenomenon in wireless communication. Typically, delay spread may be caused by a communication scenario with two or more radio signaling paths that have different signal transfer times. Generally, delay spread may also be referred to as channel length.

A large delay spread may deteriorate the communication performance. For example, the received signal quality—e.g., signal-to-interference ratio, SIR—and/or the throughput may be decreased due to the delay spread.

Therefore, there is a need for delay spread management approaches for wireless communication.

### SUMMARY

It is an object of some embodiments to solve or mitigate, alleviate, or eliminate at least some of the above or other disadvantages.

A first aspect is a method for delay spread management; performed by a radio access node configured to communicate with a user device. The method comprises transmitting control signaling to the user device, wherein the control signaling is indicative of a configuration of the user device to perform delay spread measurements, and receiving one or more delay spread report from the user device in response to the configuration.

An advantage of the first aspect is that a delay spread management method is provided for radio access node. Other possible advantages of the first aspect include improved delay spread management, improved communication performance, increased received signal quality, decreased inter-symbol interference (ISI), decreased number of re-transmissions, and increased throughput.

In some embodiments, the control signaling comprises radio resource control (RRC) signaling. In some embodiments, the control signaling comprises a CSI-measConfig message.

In some embodiments, the control signaling comprises resource indication for the delay spread measurements and/or for the one or more delay spread report. An advantage of these embodiments is that the user device acquires information regarding which communication resources comprises signaling suitable for delay spread measurements and/or which communication resources should be used for transmission of the delay spread report. Knowing which communication resources comprises signaling suitable for delay spread measurements, the user device can limit delay spread measurement efforts to such communication resources, which may be beneficial for the power consumption of the user device. Instructing the user device regarding which communication resources should be used for transmission of the delay spread report enables the network to have reports conveyed by resources that are not required by other traffic, which may enable efficient scheduling.

In some embodiments, the control signaling comprises a time domain threshold for controlling the one or more delay spread report. An advantage of these embodiments is that the delay spread reports are only transmitted when they are relevant, which may decrease signaling overhead.

In some embodiments, the control signaling comprises a power threshold for controlling the delay spread measurements and/or the one or more delay spread report. An advantage of these embodiments is that the delay spread reports only include relevant power information, which may decrease signaling overhead.

In some embodiments, the control signaling comprises an indication to include signal component power values in the one or more delay spread report.

In some embodiments, the one or more delay spread report comprises one or more of: an overall delay spread indication, a respective delay indication for at least one signal component, and a respective power indication for at least one signal component.

In some embodiments, the one or more delay spread report is comprised in uplink control information (UCI) signaling.

In some embodiments, the method further comprises receiving a delay spread measurement capability indication from the user device prior to transmitting the control signaling. An advantage of these embodiments is that the network acquires information regarding which user devices can be configured for performing delay spread measurements, which may enable network scenarios where user devices with delay spread measurement capability coexist with user devices without the delay spread measurement capability.

In some embodiments, the method further comprises-after transmitting the control signaling indicative of the configuration of the user device to perform delay spread measurements—transmitting a report request to the user device, wherein reception of at least one of the one or more delay spread report is responsive to transmitting the report request. An advantage of these embodiments is that the delay spread reports—and corresponding measurement efforts —can be limited to situations where the network considers them to be relevant, which may decrease signaling overhead and/or power consumption of the user device.

In some embodiments, transmitting the report request is responsive to one or more of: an indication that a relative speed between the radio access node and the user device is higher than a speed threshold, an indication that a frequency offset due to Doppler shift between the radio access node and the user device is higher than a frequency offset threshold, and an indication that a signal-to-interference ratio, SIR, is lower than a SIR threshold.

In some embodiments, the method further comprises—after transmitting the control signaling indicative of the configuration of the user device to perform delay spread measurements receiving a reference signal request from the user device and transmitting reference signaling accordingly, wherein reception of at least one of the one or more delay spread report is responsive to transmitting the reference signaling. An advantage of these embodiments is that the reference signaling—and corresponding delay spread measurement efforts and/or reporting—can be limited to situations where the user device considers it to be relevant, which may decrease signaling overhead and/or power consumption of the user device.

In some embodiments, transmitting the control signaling indicative of the configuration of the user device to perform delay spread measurements is responsive to one or more of: an indication that a relative speed between the radio access node and the user device is higher than a speed threshold, an indication that a frequency offset due to Doppler shift between the radio access node and the user device is higher than a frequency offset threshold, and an indication that a signal-to-interference ratio, SIR, is lower than a SIR threshold.

In some embodiments, the radio access node provides a high speed train (HST) cell and the user device resides in the HST cell.

In some embodiments, transmitting the control signaling indicative of the configuration of the user device to perform delay spread measurements comprises transmitting a HST cell indication.

In some embodiments, the method further comprises avoiding to schedule transmission on communication resources within a specified time after transmission of reference signaling for delay spread measurements. An advantage of these embodiments is that the user device is enabled to measure delay spread that extends over the non-scheduled communication resources, based on the reference signaling.

In some embodiments, the specified time is an expected delay spread and/or is indicated by the user device.

In some embodiments, the method further comprises avoiding to schedule a second transmission for the user device on communication resources within a particular time after a first transmission for the user device. An advantage of these embodiments is that ISI is decreased.

In some embodiments, the particular time corresponds to the delay spread of the user device.

A second aspect is a method for delay spread management; performed by scheduler associated with a radio access node configured to communicate with a user device. The method comprises avoiding to schedule transmission on a second communication resource that is potentially affected by delay spread related to transmission on a first communication resource.

An advantage of the second aspect is that a delay spread management method is provided for a scheduler. Other possible advantages of the second aspect include improved delay spread management, improved communication performance, increased received signal quality, decreased inter-symbol interference (ISI), decreased number of re-transmissions, and increased throughput.

In some embodiments, avoiding to schedule transmission on a second communication resource that is potentially affected by delay spread related to transmission on a first communication resource comprises avoiding to schedule transmission on communication resources within a specified time after transmission of reference signaling for delay spread measurements. An advantage of these embodiments is that the user device is enabled to measure delay spread that extends over the non-scheduled communication resources, based on the reference signaling.

In some embodiments, the specified time is an expected delay spread and/or is indicated by the user device.

In some embodiments, avoiding to schedule transmission on a second communication resource that is potentially affected by delay spread related to transmission on a first communication resource comprises avoiding to schedule a second transmission for the user device on communication resources within a particular time after a first transmission for the user device. An advantage of these embodiments is that ISI is decreased.

In some embodiments, the particular time corresponds to the delay spread of the user device.

A third aspect is a method for delay spread management; performed by a user device configured to communicate with a radio access node. The method comprises performing delay spread measurements according to a configuration indicated by control signaling received from the radio access node, and transmitting one or more delay spread report indicative of a result of the delay spread measurements to the radio access node.

An advantage of the third aspect is that a delay spread management method is provided for a user device. Other possible advantages of the third aspect include improved delay spread management, improved communication performance, increased received signal quality, decreased inter-symbol interference (ISI), decreased number of re-transmissions, and increased throughput.

In some embodiments, the method further comprises receiving the control signaling from the radio access node, wherein the control signaling is indicative of the configuration of the user device to perform delay spread measurements.

In some embodiments, the control signaling comprises radio resource control (RRC) signaling.

In some embodiments, the control signaling comprises a CSI-measConfig message.

In some embodiments, the control signaling comprises resource indication for the delay spread measurements and/or for the one or more delay spread report. An advantage of these embodiments is that the user device acquires information regarding which communication resources comprises signaling suitable for delay spread measurements and/or which communication resources should be used for transmission of the delay spread report. Knowing which communication resources comprises signaling suitable for delay spread measurements, the user device can limit delay spread measurement efforts to such communication resources, which may be beneficial for the power consumption of the user device. Instructing the user device regarding which communication resources should be used for transmission of the delay spread report enables the network to have reports conveyed by resources that are not required by other traffic, which may enable efficient scheduling.

In some embodiments, the control signaling comprises a time domain threshold for controlling the one or more delay spread report. An advantage of these embodiments is that the delay spread reports are only transmitted when they are relevant, which may decrease signaling overhead.

In some embodiments, the control signaling comprises a power threshold for controlling the delay spread measurements and/or the one or more delay spread report. An advantage of these embodiments is that the delay spread reports only include relevant power information, which may decrease signaling overhead.

In some embodiments, the control signaling comprises an indication to include signal component power values in the one or more delay spread report.

In some embodiments, the one or more delay spread report comprises one or more of: an overall delay spread indication, a respective delay indication for at least one signal component, and a respective power indication for at least one signal component.

In some embodiments, the one or more delay spread report is comprised in uplink control information (UCI) signaling.

In some embodiments, the method further comprises transmitting a delay spread measurement capability indication to the radio access node. An advantage of these embodiments is that the network acquires information regarding which user devices can be configured for performing delay spread measurements, which may enable network scenarios where user devices with delay spread measurement capability coexist with user devices without the delay spread measurement capability.

In some embodiments, the method further comprises receiving a report request from the radio access node, wherein transmission of at least one of the one or more delay spread report is responsive to receiving the report request. An advantage of these embodiments is that the delay spread reports—and corresponding measurement efforts—can be limited to situations where the network considers them to be relevant, which may decrease signaling overhead and/or power consumption of the user device.

In some embodiments, the method further comprises-after receiving the control signaling indicative of the configuration to perform delay spread measurements—transmitting a reference signal request to the radio access node, wherein at least some of the delay spread measurements are performed on reference signaling received in response to the transmission of the reference signal request. An advantage of these embodiments is that the reference signaling—and corresponding delay spread measurement efforts and/or reporting—can be limited to situations where the user device considers it to be relevant, which may decrease signaling overhead and/or power consumption of the user device.

In some embodiments, transmitting the reference signal request is responsive to one or more of: an indication that a relative speed between the radio access node and the user device is higher than a speed threshold, an indication that a frequency offset due to Doppler shift between the radio access node and the user device is higher than a frequency offset threshold, and an indication that a signal-to-interference ratio, SIR, is lower than a SIR threshold.

In some embodiments, the radio access node provides a high speed train (HST) cell and the user device resides in the HST cell.

In some embodiments, the control signaling indicative of the configuration comprises a HST cell indication.

A fourth aspect is a computer program product comprising a non-transitory computer readable medium, having thereon a computer program comprising program instructions. The computer program is loadable into a data processing unit and configured to cause execution of the method according to any of the first, second, and third aspects when the computer program is run by the data processing unit.

An advantage of the fourth aspect is that a computer program product is provided for enabling delay spread management. Other possible advantages of the fourth aspect include improved delay spread management, improved communication performance, increased received signal quality, decreased inter-symbol interference (ISI), decreased number of re-transmissions, and increased throughput.

A fifth aspect is an apparatus for delay spread management; for a radio access node configured to communicate with a user device. The apparatus comprises controlling circuitry, which is configured to cause transmission of control signaling to the user device, wherein the control signaling is indicative of a configuration of the user device to perform delay spread measurements, and reception of one or more delay spread report from the user device in response to the configuration.

An advantage of the fifth aspect is that an apparatus configured for delay spread management is provided for a radio access node. Other possible advantages of the fifth aspect include improved delay spread management, improved communication performance, increased received signal quality, decreased inter-symbol interference (ISI), decreased number of re-transmissions, and increased throughput.

A sixth aspect is an apparatus for delay spread management; for a scheduler associated with a radio access node configured to communicate with a user device. The apparatus comprises controlling circuitry, which is configured to cause avoidance of scheduling transmission on a second communication resource that is potentially affected by delay spread related to transmission on a first communication resource.

An advantage of the sixth aspect is that an apparatus configured for delay spread management is provided for a scheduler. Other possible advantages of the sixth aspect include improved delay spread management, improved communication performance, increased received signal quality, decreased inter-symbol interference (ISI), decreased number of re-transmissions, and increased throughput.

A seventh aspect is a radio access node comprising the apparatus according to any of the fifth and sixth aspects.

An eighth aspect is a server node comprising the apparatus according to the sixth aspect.

A ninth aspect is an apparatus for delay spread management; for a user device configured to communicate with a radio access node. The apparatus comprises controlling circuitry, which is configured to cause performance of delay spread measurements according to a configuration indicated by control signaling received from the radio access node, and transmission of one or more delay spread report indicative of a result of the delay spread measurements to the radio access node.

An advantage of the ninth aspect is that an apparatus configured for delay spread management is provided for a user device. Other possible advantages of the ninth aspect include improved delay spread management, improved communication performance, increased received signal quality, decreased inter-symbol interference (ISI), decreased number of re-transmissions, and increased throughput.

A tenth aspect is a user device comprising the apparatus of the ninth aspect.

In some embodiments, any of the above aspects may additionally have features identical with or corresponding to any of the various features as explained above for any of the other aspects.

An advantage of some embodiments is that delay spread management approaches are provided for wireless communication.

An advantage of some embodiments is that improved delay spread management is enabled; compared to other approaches.

An advantage of some embodiments is that communication performance is improved—e.g., for situations with a relatively large delay spread—compared to other approaches.

An advantage of some embodiments is that the received signal quality is increased-e.g., for situations with a relatively large delay spread—compared to other approaches.

An advantage of some embodiments is that the inter-symbol interference (ISI) is decreased e.g., for situations with a relatively large delay spread—compared to other approaches.

An advantage of some embodiments is that the number of re-transmissions is decreased—e.g., for situations with a relatively large delay spread—compared to other approaches.

An advantage of some embodiments is that the throughput is increased—e.g., for situations with a relatively large delay spread—compared to other approaches.

An example of a relatively large delay spread is when the delay spread is larger than a delay spread threshold related to the duration of the cyclic prefix (CP) for communication based on orthogonal frequency division duplex (OFDM). For example, the delay spread threshold may be equal to the duration of one CP, or a multiple thereof. Alternatively, the delay spread threshold may be equal to a fraction of the duration of one CP; e.g., half of the duration of one CP.

Another example of a relatively large delay spread is when the delay spread is larger than a delay spread threshold related to the duration of a communication symbol; e.g., an OFDM symbol. For example, the delay spread threshold may be equal to the duration of one communication symbol, or a multiple thereof. Alternatively, the delay spread threshold may be equal to a fraction of the duration of one communication symbol; e.g., half of the duration of one communication symbol.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments. Features that are typically optional are represented as dashed.

FIG. 1 is a schematic drawing illustrating an example scenario according to some embodiments;

FIG. 2 is a flowchart illustrating example method steps according to some embodiments;

FIG. 3 is a flowchart illustrating example method steps according to some embodiments;

FIG. 4A is a signaling diagram illustrating example signaling according to some embodiments;

FIG. 4B is a signaling diagram illustrating example signaling according to some embodiments;

FIG. 4C is a signaling diagram illustrating example signaling according to some embodiments;

FIG. 5A is a schematic drawing illustrating an example scheduling approach according to some embodiments;

FIG. 5B is a schematic drawing illustrating an example scheduling approach according to some embodiments;

FIG. 6 is a schematic block diagram illustrating an example apparatus according to some embodiments;

FIG. 7 is a schematic block diagram illustrating an example apparatus according to some embodiments; and

FIG. 8 is a schematic drawing illustrating an example computer readable medium according to some embodiments.

### DETAILED DESCRIPTION

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

Generally, when a radio access node is referred to herein, it is meant to encompass any suitable radio access node. One example of a suitable radio access node is a radio base station (BS) configured for operation in accordance with technical specifications under the Third Generation Partnership Project (3GPP; e.g., long term evolution—LTE, new radio—NR, etc.); e.g., an eNB, a gNB, a radio unit (RU), or similar. Another example of a suitable radio access node is an access point (AP) configured for operation in accordance with technical specifications under IEEE 802.11.

Also generally, when a user device is referred to herein, it is meant to encompass any suitable user device. One example of a suitable user device is a user equipment (UE) configured for operation in accordance with 3GPP technical specifications. Another example of a suitable user device is a station (STA; e.g., a non-AP STA) configured for operation in accordance with IEEE802.11 technical specifications.

Also generally, any threshold mentioned herein may have a pre-defined fixed value, or may be configurable by the network.

In the following, delay spread management approaches for wireless communication will be described and exemplified.

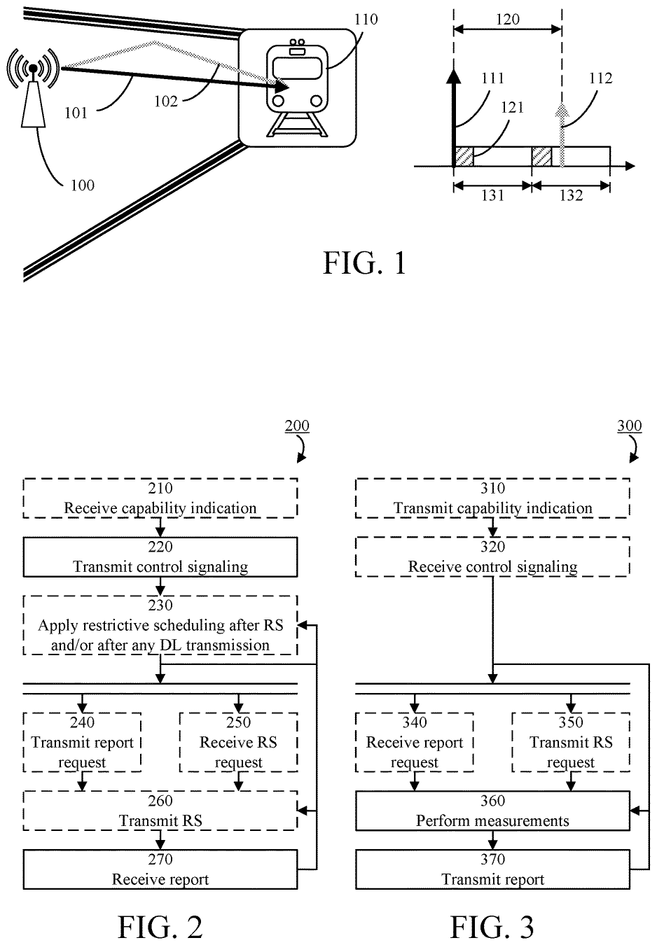

FIG 1 schematically illustrates an example scenario where delay spread management may be beneficial.

The left part of FIG. 1 shows a high speed train 110 in a tunnel scenario. In the illustrated scenario, communication signals from a radio access node 100 reaches a receiver onboard the train via a direct signaling path 101 and another signaling path 102, wherein the signaling path 102 is caused by reflection at the tunnel wall. Thereby, the signaling path 102 has a longer signal transfer time than the signaling path 101, and a delay spread arises.

The right part of FIG. 1 illustrates the delay spread 120 in a time domain diagram, where the received signal portion of the direct signaling path 101 is illustrated as 111 and the received signal portion of the reflected signaling path 102 is illustrated as 112. For exemplification, the delay spread 120 is shown in relation to a first OFDM symbol 131 and a second OFDM symbol 132.

When the delay spread 120 is relatively large, the communication performance may be deteriorated. For example, when the delay spread 120 is longer than the CP 121 of the OFDM symbol 131, ISI from the OFDM symbol 132 will decrease the reception quality of the OFDM symbol 131. Typically, the higher the power of the reflected signaling path 102 is, the more severe the communication performance degradation becomes.

FIGS. 2 and 3 illustrate an example method 200 for a radio access node configured to communicate with a user device and a corresponding example method 300 for the user device. Thus, the method 200 may be performed by the radio access node and the method 300 may be performed by the user device.

The methods 200, 300 are methods for delay spread management.

According to step 220, the radio access node transmits control signaling to the user device, which may be received by the user device in step 320. The control signaling is indicative of a configuration of the user device to perform delay spread measurements. The control signaling also configures—explicitly or implicitly—the user device to report the delay spread measurements to the radio access node (compare with steps 270, 370).

The control signaling may comprise any suitable signaling. For example, the control signaling may comprise radio resource control (RRC) signaling; e.g., a CSI-measConfig message according to 3GPP specifications.

The transmission of the control signaling may be triggered by one or more events or conditions (e.g., an indication that the delay spread could be relatively high).

For example, the transmission of the control signaling may be responsive to an indication that a signal-to-interference ratio (SIR) is lower than a SIR threshold; or correspondingly for another suitable signal quality metric, e.g., reference signal received quality (RSRQ), reference signal received power (RSRP), re-transmission rate, or similar. This may be implemented, for example, by considering signal quality feedback from the user device.

Alternatively or additionally, the transmission of the control signaling may be responsive to an indication that a relative speed between the radio access node and the user device is higher than a speed threshold. For example, the relative speed being higher than a speed threshold could be associated with relatively high delay spread for typical 3GPP scenarios, such as a high speed scenario.

This may be implemented by using a UE speed mode—e.g., low, medium, high—as an indication; e.g., transmitting the control signaling when the UE is in high speed mode.

Alternatively or additionally, the transmission of the control signaling may be responsive to an indication that a frequency offset due to Doppler shift between the radio access node and the user device is higher than a frequency offset threshold. This may be implemented, for example, by considering frequency offset feedback from the user device; e.g., a relatively high frequency offset between the radio access node and the user device may be assumed to correspond to a relatively high speed between the radio access node and the user device, which in turn may be assumed to a relatively high delay spread.

Yet alternatively or additionally, the user device camping on, or being served by, a high speed train (HST) cell may be seen as an indication that a relative speed between the radio access node and the user device is higher than a speed threshold.

More generally, a radio access node providing a HST cell may transmit the control signaling to user devices associated with the HST cell; e.g., all user devices associated with the HST cell. The control signaling may take the implicit form of a HST cell indication. Thus, transmitting the control signaling indicative of the configuration of the user device to perform delay spread measurements may comprise—e.g., consist of—transmitting a HST cell indication. Consequently, a user device that receives a HST cell indication may interpret it as a configuration to perform and report delay spread measurements.

In step 260, the user device performs delay spread measurements according to the configuration indicated by the control signaling. The delay spread measurements may be performed according to any suitable approach; e.g., a suitable approach of the prior art. For example, the delay spread measurements may be performed on reference signaling (RS) transmitted by the radio access node in step 260. Example reference signals suitable for delay spread measurements include synchronization signal blocks (SSB), and channel state information reference signals (CSI-RS).

According to step 370, the user device transmits one or more delay spread report indicative of a result of the delay spread measurements to the radio access node, which may be received by the radio access node in step 270.

The delay spread report may be comprised in any suitable signaling. For example, the delay spread report may be comprised in uplink control information (UCI) signaling according to 3GPP specifications; e.g., in an additionally introduced field.

The delay spread report may comprise any suitable information relating to the delay spread measurements. Generally, the delay spread report may comprise the raw result of the delay spread measurements and/or information derived therefrom.

For example, the delay spread report may comprise an overall delay spread indication; e.g., a time duration. Alternatively or additionally, the delay spread report may comprise a respective delay indication for at least one signal component contributing to the delay spread. Yet alternatively or additionally, the delay spread report may comprise a respective power indication for at least one signal component contributing to the delay spread. For example, the at least one signal component contributing to the delay spread may be a plurality of-typically at least two-signal components contributing to the delay spread.

The information comprised in the delay spread report may take any suitable form; e.g., actual values or more compact representations, such as indices.

In a typical example, the delay spread report may comprise delay information and power information for each signal component to be reported.

Generally, the control signaling (steps 220, 320) may comprise any suitable collection of information for configuring the user devise to perform and report delay spread measurements. For example, the control signaling may comprise a resource indication for the delay spread measurements and/or for the one or more delay spread report.

Thus, the resource indication may identify one or more communication resources for the delay spread measurements; e.g., communication resources where reference signals- or other signals suitable for delay spread measurements—will be transmitted. The user device may perform the delay spread measurements accordingly in step 360; i.e., using at least some of the indicated communication resources. In some embodiments, the resource indication for the delay spread measurements may be carried by csi-ResourceConfig of the CSI-measConfig message according to 3GPP specifications; e.g., in an additionally introduced field.

Alternatively or additionally, the resource indication may identify one or more communication resources for the delay spread report(s); e.g., communication resources where the report(s) will be expected. The user device may transmit the delay spread reports accordingly in step 370; i.e., using at least some of the indicated communication resources. In some embodiments, the resource indication for the delay spread report(s) may be carried by csi-ReportConfig of the CSI-measConfig message according to 3GPP specifications; e.g., in an additionally introduced field. Generally, a communication resource may comprise a time resource and/or a frequency resource. For example, a communication resource may comprise a time/frequency resource; e.g., a physical resource block (PRB).

Alternatively or additionally, the control signaling may comprise a time domain threshold for controlling the one or more delay spread report. For example, the time domain threshold may specify a smallest measured delay spread for which delay spread reporting is to take place. The smallest measured delay spread for which delay spread reporting is to take place may be equal—or otherwise relating—to a CP length in an OFDM scenario, for example. The user device may transmit the delay spread reports accordingly in step 370; e.g., only when the delay spread is larger than, or equal to, the time domain threshold.

Yet alternatively or additionally, the control signaling may comprise an indication to include signal component power values in the one or more delay spread report. The user device may transmit the delay spread reports accordingly in step 370.

Yet alternatively or additionally, the control signaling may comprise a power threshold for controlling the delay spread measurements and/or the one or more delay spread report.

For example, one power threshold may specify a smallest signal component power for which information of the corresponding signal component is to be included in the delay spread report. The user device may transmit the delay spread reports accordingly in step 370; e.g., only including information of signal components with signal component power larger than, or equal to, the power threshold.

Alternatively or additionally, one—possibly different—power threshold may provide a definition of the delay spread; e.g., specifying a smallest signal component power for which the corresponding signal component is to be considered as contributing to the delay spread, and/or specifying a smallest time duration with accumulated signal component power exceeding the power threshold as the delay spread. The power threshold(s) may be defined in absolute power or in relative power; e.g., as a portion of the total received power. The user device may derive the delay spread accordingly in step 360 and/or step 370.

In a typical example, the control signaling—e.g., csi-ReportConfig—comprises an instruction to perform delay spread measurements, an indication of whether or not the signal component power shall be reported, one or more power threshold, and a time domain threshold.

As already implied, the delay spread reporting may be seen as generally response to the configuration of steps 220, 320. In some embodiments, the delay spread reporting is “always on” when the user device is configured for delay spread measurements. For example, the delay spread reporting may occur periodically, semi-persistently, or aperiodically—depending on network configurations—when the user device is configured for delay spread measurements. Alternatively, the delay spread reporting occurs only when one or more further condition is met; e.g., only when the delay spread is larger than, or equal to, the time domain threshold.

In some embodiments, the delay spread reporting is specifically requested by the radio access node. This is exemplified by step 240, in which the radio access node transmits a report request to the user device, which may be received by the user device in step 340. Then, the transmission and reception of the delay spread report (steps 270, 370) may be seen as responsive to the report request. This transmission and reception of the delay spread report may be “always on” and occur each time it is requested, or may occur only when one or more further condition is met as exemplified above.

Similarly to what has been explained above for the transmission of the control signaling; the transmission of the report request may be triggered by one or more events or conditions; e.g., an indication that the delay spread could be relatively high. For example, the transmission of the report request may be responsive to one or more of: an indication that the relative speed between the radio access node and the user device is higher than a speed threshold, an indication that the frequency offset due to Doppler shift between the radio access node and the user device is higher than a frequency offset threshold, and an indication that a signal-to-interference ratio (SIR) is lower than a SIR threshold.

Also similarly to what has been explained above for the transmission of the control signaling; the report request may comprise a resource indication for the delay spread measurements and/or for the one or more delay spread report.

In some embodiments, the delay spread measurement and reporting is specifically initiated by the user device. This is exemplified by step 350, in which the user device transmits a reference signal request to the radio access node, which may be received by the radio access node in step 250. Then, the transmission of reference signaling in step 260—on which at least some of the delay spread measurements of step 360 are performed—may be seen as responsive to the reference signal request, and the transmission and reception of the delay spread report (steps 270, 370) may be seen as responsive to the reference signal request and/or to the transmission of reference signaling. This transmission and reception of the delay spread report may be “always on” and occur each time it is requested, or may occur only when one or more further condition is met as exemplified above.

Similarly to what has been explained above for the transmission of the control signaling; the transmission of the reference signal request may be triggered by one or more events or conditions; e.g., an indication that the delay spread could be relatively high. For example, the transmission of the report request may be responsive to one or more of: an indication that the relative speed between the radio access node and the user device is higher than a speed threshold, an indication that the frequency offset due to Doppler shift between the radio access node and the user device is higher than a frequency offset threshold, and an indication that a signal-to-interference ratio (SIR) is lower than a SIR threshold.

Also similarly to what has been explained above for the transmission of the control signaling; the reference signal request may comprise a resource indication for the delay spread measurements and/or for the one or more delay spread report.

The report request and the reference signal request may be used as separate approaches, or may be used in a combined approach. For example, a report request from the radio access node may trigger a reference signal request from the user device according to some embodiments.

As illustrated by step 310, the user device transmits a delay spread measurement capability indication to the radio access node according to some embodiments, which is received by the radio access node in step 210.

The delay spread measurement capability indication may be conveyed by any suitable signaling. For example, the delay spread measurement capability indication may be comprised in radio resource control (RRC) signaling.

The delay spread measurement capability indication is indicative of the capability of the user device to perform and report delay spread measurements.

In some embodiments, the radio access node transmits (step 220) the control signaling to configure the user device to perform delay spread measurements only when a delay spread measurement capability indication has been received (step 210) from that user device. Thus, the transmission of the control signaling may be conditioned on reception of the delay spread measurement capability indication.

In some embodiments, the radio access node can transmit (step 220) the control signaling to configure the user device to perform delay spread measurements regardless of whether or not a delay spread measurement capability indication has been received (step 210) from that user device. For example, it may be assumed that all user devices have delay spread measurement capability in some scenarios. Alternatively, the control signaling may be transmitted (step 220) blindly, and the radio access node may be prepared to not receive delay spread measurement reports from all user devices it has attempted to configure.

Step 230 illustrates a supplementary approach for delay spread management. Typically, step 230 may be combined with the steps already described. Alternatively, step 230 may be seen as an alternative approach to delay spread management.

In step 230, restrictive scheduling is applied after reference signal transmission and/or after other downlink transmission. More generally, step 230 may be seen as exemplifying an approach of avoiding to schedule transmission on a second communication resource that is potentially affected by delay spread related to transmission on a first communication resource.

For example, the restrictive scheduling may comprise avoiding to schedule transmission on communication resources within a specified time after transmission of reference signaling for delay spread measurements. In some embodiments, the restrictive scheduling comprises avoiding to schedule downlink transmission—such as one or more of: physical downlink dedicated channel (PDDCH), physical downlink shared channel (PDSCH), and/or physical downlink control channel (PDCCH)—on communication resources within the specified time after transmission of reference signaling for delay spread measurements. The specified time may be associated with the delay spread. The specified time may, for example, be an expected delay spread, a worst case delay spread, an average delay spread, a previously—e.g., most recently—reported delay spread, or similar; possibly with addition of a margin. The specified time may be determined by the radio access node and/or may be requested/indicated by the user device.

Alternatively or additionally, the restrictive scheduling may comprise avoiding to schedule a second transmission for the user device on communication resources within a particular time after a first transmission—e.g., downlink transmission, such as one or more of: PDDCH, PDSCH, and/or PDCCH—for the user device. In some embodiments, the restrictive scheduling comprises avoiding to schedule downlink transmission—such as one or more of: PDDCH, PDSCH, and/or PDCCH—for the user device on communication resources within the particular time after the first transmission for the user device. The particular time may be associated with the delay spread. The particular time may, for example, be an expected delay spread, a worst case delay spread, an average delay spread, a previously—e.g., most recently—reported delay spread, or similar; possibly with addition of a margin. The particular time may be determined by the radio access node and/or may be requested/indicated by the user device(s).

In some embodiments, the particular time corresponds to the delay spread of the user device. For example, assuming a first transmission to a user device in a first frequency resource, the restrictive scheduling may comprise avoiding to schedule a second transmission to the user device in any frequency for a particular time that corresponds to the delay spread of the user device.

Information related to the scheduling avoidance may be comprised in any suitable signaling between the radio access node and the user device. For example, the radio access node may inform the user device about which communication resources will be unscheduled; for all user devices, or for the user device receiving the information. Such informing may be included in the control signaling of step 220, in the report request of step 240, or in separate signaling. Alternatively or additionally, the user device may request the radio access node to leave specific communication resources unscheduled; for all user devices, or for the user device receiving the information. Such a request may be included in the delay spread measurement capability indication of step 310, in the reference signal request of step 350, or in separate signaling.

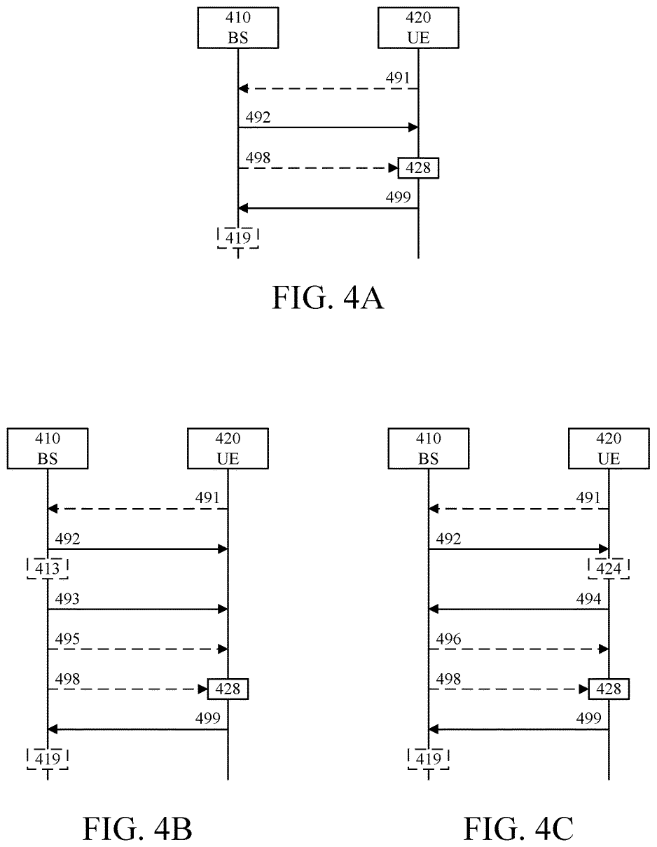

FIGS. 4A-C illustrate example signaling according to some embodiments, between a radio access node—exemplified by a base station, BS, 410—and a user device—exemplified by a user equipment, UE, 420. The signaling of FIGS. 4A-C may be seen as exemplifying signaling in relation to performing the method 200 of FIG. 2 and/or the method 300 of FIG. 3.

FIG. 4A shows a delay spread measurement capability indication 491 conveyed from the user device to the radio access node (compare with 210 of FIGS. 2 and 310 of FIG. 3). FIG. 4A also shows control signaling 492 conveyed from the radio access node to the user device for configuration of the user device to perform delay spread measurements (compare with 220 of FIGS. 2 and 320 of FIG. 3). Furthermore, FIG. 4A shows reference signals 498 transmitted by the radio access node (compare with 260 of FIG. 2) and corresponding delay spread measurements 428 being performed on the reference signals by the user device (compare with 360 of FIG. 3). A delay spread report 499 is conveyed from the user device to the radio access node (compare with 270 of FIGS. 2 and 370 of FIG. 3), and subsequent scheduling restriction by the radio access node—e.g., based on the delay spread report 499—is represented by 419 (compare with 230 of FIG. 2).

FIG. 4B differs from FIG. 4A in that a report request 493 is conveyed from the radio access node to the user device (compare with 240 of FIGS. 2 and 340 of FIG. 3). The report request may be triggered based on feedback from the user device; e.g., a channel state information (CSI) report indicating that received SIR is below a SIR threshold. The triggering of the report request at the radio access node is represented by 413. Also shown is information 495 conveyed from the radio access node to the user device regarding how many communication resources will be unscheduled following the reference signals.

FIG. 4C differs from FIG. 4A in that a reference signal request 494 is conveyed from the user device to the radio access node (compare with 250 of FIGS. 2 and 350 of FIG. 3). The reference signal request may be triggered by detection at the user device; e.g., detecting that received SIR is below a SIR threshold. The triggering of the reference signal request at the user device is represented by 424. Also shown is information 496 conveyed from the radio access node to the user device regarding how many communication resources will be unscheduled following the reference signals; e.g., a confirmation of a request by the user device for unscheduled resources comprised in 494.

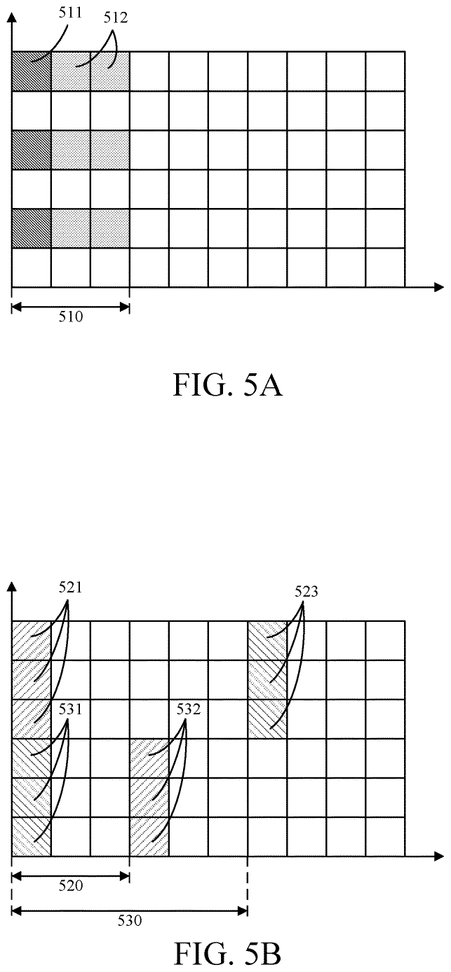

FIGS. 5A-B illustrate example scheduling approaches for restrictive scheduling applied after reference signal transmission and/or after other downlink transmission (compare with step 230 of FIG. 2). The exemplification is illustrated in a time/frequency grid where each square represents a PRB, the x-axis represents time, and the y-axis represents frequency.

FIG. 5A shows two PRBs 512 being unscheduled after a reference signal 511, which may be suitable when the delay spread 510 extends over three PRBs. The illustration of FIG. 5A may be seen as an exemplification of restrictive scheduling by avoiding to schedule transmission on communication resources 512 within a specified time after transmission of reference signaling 511 for delay spread measurements.

Scheduling restriction after reference signals may be applied depending on the capabilities and implementation of the user device. For example, if the user device is able to detect residual RS multi-path components while receiving other downlink transmissions (e.g., PDCCH, PDSCH, etc.), the scheduling restriction may not be needed.

In some embodiments, the user device may request a number of resources to be left empty by the scheduling; e.g., in the delay spread measurement capability indication of step 310, 491, or in the reference signal request of step 350, 494. For example, such a request may be updated dynamically based on the delay spread currently experienced.

When the user device requests a number of resources to be left empty by the scheduling (compare with 494 of FIG. 4C), the radio access node may respond by a confirmation message according to some embodiments (compare with 496 of FIG. 4C).

FIG. 5B shows three PRBs 521 used for a first transmission to one user device, UE1, with a delay spread 520 extending over three PRBs, and three PRBs 531 used for a first transmission to another user device, UE2, with a delay spread 530 extending over six PRBs. For subsequent transmission to UE1, two PRBs may be left unscheduled after the first transmission, and for subsequent transmission to UE2, five PRBs may be left unscheduled after the first transmission. Assuming that UE1 and UE2 are to switch between frequency resources, UE1 may be scheduled in PRBs 532, while UE2 may be scheduled in PRBs 523. The illustration of FIG. 5B may be seen as an exemplification of restrictive scheduling by avoiding to schedule a second transmission for the user device on communication resources within a particular time after a first transmission for the user device.

FIG. 5B illustrates an example of an approach wherein the communication network aims to not to schedule resources (e.g., PDSCH, PDCCH, etc.) which are overlapped by—e.g., relatively strong—multi-path delay components of transmissions to other UEs. In the example, there are two user devices, UE1 and UE2. The network schedules the UE1 and UE2 on the same first OFDM symbol but on different PRBs in the frequency domain, as illustrated by 521, 531. Based on reported delay spreads 520, 530 for UE1 and UE2, respectively, the network restricts successive scheduling to avoid symbols impacted by delay spread; e.g., by making such resources unavailable to the scheduler.

Some embodiments are useful in high speed train (HST) scenarios and/or other typical 3GPP high speed scenarios. With the development of high speed trains, it will be increasingly common with wireless communication situations between a stationary node and a device on a high speed train. In HST scenarios, as well as in other scenarios, good signal quality and stable wireless communication connection may be important for end user service.

There are many challenges for wireless communication in HST scenarios and/or other typical 3GPP high speed scenarios.

One such challenge is the typically strong power of the multiple-path components. Another such challenge is multiple-path delay greater than CP of OFDM symbol. For example, it may be challenging for a receiver to determine the main path by signal strength analysis of signal path components, and/or to remove ISI when the multiple-path delay—i.e., the delay spread—is longer than the CP in OFDM scenarios.

According to some embodiments, approaches are provided that enable the ISI introduced by delay spread longer than the CP to be decreased, or entirely removed, which may in turn decrease the re-transmission rate and/or increase throughput. This may be accomplished by configuring the user device to detect and assess the delay spread, and to report delay spread information to the radio access node. Particular signaling protocols are also suggested.

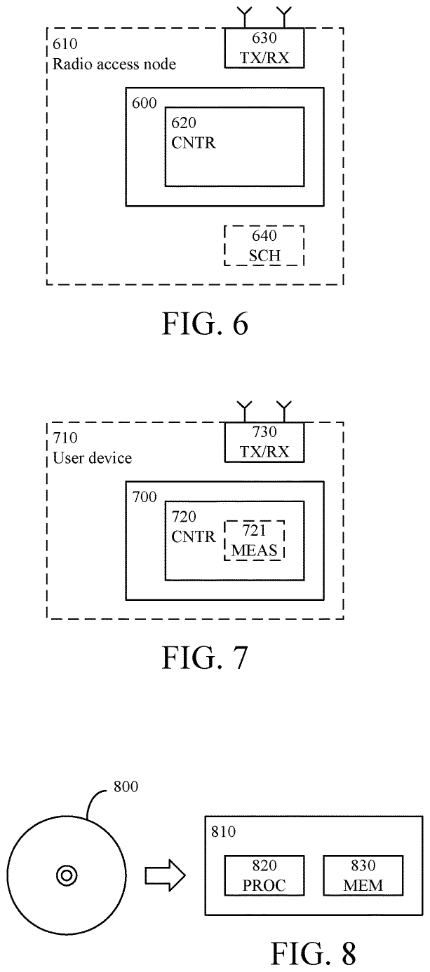

FIG. 6 schematically illustrates an example apparatus 600 according to some embodiments. The apparatus 600 is for delay spread management. For example, the apparatus 600 may be configured to cause—e.g., configured to perform—one or more method steps of the method 200 of FIG. 2. Alternatively or additionally, the apparatus 600 may be comprised in a radio access node 610 configured to communicate with a user device; or in a server node, such as a network control node.

The apparatus 600 comprises a controller (CNTR; e.g., controlling circuitry or a control module) 620.

The controller 620 may be configured to cause transmission of control signaling to the user device, wherein the control signaling is indicative of a configuration of the user device to perform delay spread measurements (compare with step 220 of FIG. 2).

To this end, the controller 620 may comprise, or be otherwise associated with—e.g., connected, or connectable, to—a transmitter (TX; e.g., transmitting circuitry or a transmission module). The transmitter may be configured to transmit the control signaling.

The controller 620 may also be configured to cause reception of one or more delay spread report from the user device in response to the configuration (compare with step 270 of FIG. 2).

To this end, the controller 620 may comprise, or be otherwise associated with—e.g., connected, or connectable, to—a receiver (RX; e.g., receiving circuitry or a reception module). The receiver may be configured to receive the delay spread report.

In FIG. 6, the transmitter and receiver are collectively illustrated as a transceiver (TX/RX) 630. In some embodiments, the controller 620 is also configured to cause transmission of reference signaling (compare with step 260 of FIG. 2). For example, the transmitter may be configured to transmit the reference signaling.

In some embodiments, the controller 620 is also configured to cause reception of a delay spread measurement capability indication from the user device (compare with step 210 of FIG. 2). For example, the receiver may be configured to receive the delay spread measurement capability indication.

In some embodiments, the controller 620 is also configured to cause transmission of a report request to the user device (compare with step 240 of FIG. 2). For example, the transmitter may be configured to transmit the report request.

In some embodiments, the controller 620 is also configured to cause reception of a reference signal request from the user device (compare with step 250 of FIG. 2). For example, the receiver may be configured to receive the reference signal request.

In some embodiments, the controller 620 is configured to cause avoidance of scheduling transmission on a second communication resource that is potentially affected by delay spread related to transmission on a first communication resource (compare with step 230 of FIG. 2), e.g., avoidance of scheduling of transmission on communication resources within a specified time after transmission of reference signaling for delay spread measurements, and/or avoidance of scheduling of a second transmission for the user device on communication resources within a particular time after a first transmission for the user device.

To this end, the controller 620 may comprise, or be otherwise associated with—e.g., connected, or connectable, to—a scheduler (SCH; e.g., scheduling circuitry or a scheduler module) 640. The scheduler 640 may be configured to avoid scheduling transmission on a second communication resource that is potentially affected by delay spread related to transmission on a first communication resource.

It should be noted that, while the transceiver 630 typically resides in the radio access node, the scheduler 640 may reside in the radio access node or in a server node. In the latter case, the controller may reside in the radio access node or in the server node. When the scheduler 640 resides in a server node, scheduling information is provided from the server node to the radio access node, and feedback from the user device—or information derived therefrom—may be provided from the radio access node to the server node for use in the scheduling process. The feedback from the user device may, for example, comprise delay spread reports, CSI reports, etc.

FIG. 7 schematically illustrates an example apparatus 700 according to some embodiments. The apparatus 700 is for delay spread management. For example, the apparatus 700 may be configured to cause—e.g., configured to perform—one or more method steps of the method 300 of FIG. 3. Alternatively or additionally, the apparatus 700 may be comprised in a user device 710 configured to communicate with a radio access node.

The apparatus 700 comprises a controller (CNTR; e.g., controlling circuitry or a control module) 720.

The controller 720 may be configured to cause performance of delay spread measurements according to a configuration indicated by control signaling received from the radio access node (compare with step 360 of FIG. 3).

To this end, the controller 720 may comprise, or be otherwise associated with—e.g., connected, or connectable, to—a measurer (MEAS; e.g., measuring circuitry or a measurement module) 721. The measurer 721 may be configured to perform the delay spread measurements.

The controller 720 may also be configured to cause transmission of one or more delay spread report indicative of a result of the delay spread measurements to the radio access node (compare with step 370 of FIG. 3).

To this end, the controller 720 may comprise, or be otherwise associated with—e.g., connected, or connectable, to—a transmitter (TX; e.g., transmitting circuitry or a transmission module). The transmitter may be configured to transmit the delay spread report.

The controller 720 may also be configured to cause reception of the control signaling from the radio access node, wherein the control signaling is indicative of the configuration of the user device to perform delay spread measurements (compare with step 320 of FIG. 3).

To this end, the controller 720 may comprise, or be otherwise associated with—e.g., connected, or connectable, to—a receiver (RX; e.g., receiving circuitry or a reception module). The receiver may be configured to receive the delay spread report.

In FIG. 7, the transmitter and receiver are collectively illustrated as a transceiver (TX/RX) 730.

In some embodiments, the controller 720 is also configured to cause transmission of a delay spread measurement capability indication to the radio access node (compare with step 310 of FIG. 3). For example, the transmitter may be configured to transmit the delay spread measurement capability indication.

In some embodiments, the controller 720 is also configured to cause reception of a report request from the radio access node (compare with step 340 of FIG. 3). For example, the receiver may be configured to receive the report request.

In some embodiments, the controller 720 is also configured to cause transmission of a reference signal request to the radio access node (compare with step 350 of FIG. 3). For example, the transmitter may be configured to transmit the reference signal request.

Generally, it should be noted that features and advantages described in connection with one of the Figures herein, are, when suitable, equally applicable—mutatis mutandis—to any of the other Figures; even if not explicitly mention in connection thereto.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a radio access node or a user device.

Embodiments may appear within an electronic apparatus (such as a radio access node or a user device) comprising arrangements, circuitry, and/or logic according to any of the embodiments described herein. Alternatively or additionally, an electronic apparatus (such as a radio access node or a user device) may be configured to perform methods according to any of the embodiments described herein.

Generally, when an arrangement is referred to herein, it is to be understood as a physical product; e.g., an apparatus. The physical product may comprise one or more parts, such as controlling circuitry in the form of one or more controllers, one or more processors, or the like.

According to some embodiments, a computer program product comprises a non-transitory computer readable medium such as, for example, a universal serial bus (USB) memory, a plug-in card, an embedded drive, or a read only memory (ROM). FIG. 8 illustrates an example computer readable medium in the form of a compact disc (CD) ROM 800. The computer readable medium has stored thereon a computer program comprising program instructions. The computer program is loadable into a data processor (PROC; e.g., a data processing unit) 820, which may, for example, be comprised in a radio access node or a user device 810. When loaded into the data processor, the computer program may be stored in a memory (MEM) 830 associated with, or comprised in, the data processor. According to some embodiments, the computer program may, when loaded into, and run by, the data processor, cause execution of method steps according to, for example, any of method described herein; e.g., as illustrated in FIGS. 2 and 3.

As already mentioned, the radio access node and the user device may be a radio base station (BS) and a user equipment (UE); configured for operation in accordance with 3GPP technical specifications. Some further exemplification will be provided in the following, wherein the radio access node is exemplified a network node.

An example communication system includes a telecommunication network that includes an access network, such as a radio access network (RAN), and a core network, which includes one or more core network nodes. The access network includes one or more access network nodes, or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network includes one or more Open-RAN (ORAN) network nodes. An ORAN network node is a node in the telecommunication network that supports an ORAN specification (e.g., a specification published by the O-RAN Alliance, or any similar organization) and may operate alone or together with other nodes to implement one or more functionalities of any node in the telecommunication network, including one or more network nodes and/or core network nodes.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes facilitate direct or indirect connection of user equipment (UE) to the core network over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system may include any number of wired or wireless networks, network nodes, UEs, and/or any other components or systems that may facilitate or participate in the communication of data and/or signals whether via wired or wireless connections. The communication system may include and/or interface with any type of communication, telecommunication, data, cellular, radio network, and/or other similar type of system.

The UEs may be any of a wide variety of communication devices, including wireless devices arranged, configured, and/or operable to communicate wirelessly with the network nodes and other communication devices. Similarly, the network nodes are arranged, capable, configured, and/or operable to communicate directly or indirectly with the UEs and/or with other network nodes or equipment in the telecommunication network to enable and/or provide network access, and/or to perform other functions, such as administration in the telecommunication network.

In the example, the core network connects the network nodes to one or more hosts. These connections may be direct or indirect via one or more intermediary networks or devices. In other examples, network nodes may be directly coupled to hosts. The core network includes one more core network nodes that are structured with hardware and software components. Features of these components may be substantially similar to those described with respect to the UEs, network nodes, and/or hosts, such that the descriptions thereof are generally applicable to the corresponding components of the core network node. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host may be under the ownership or control of a service provider other than an operator or provider of the access network and/or the telecommunication network, and may be operated by the service provider or on behalf of the service provider. The host may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network is a cellular network that implements 3GPP standardized features. Accordingly, the telecommunications network may support network slicing to provide different logical networks to different devices that are connected to the telecommunication network. For example, the telecommunications network may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs are configured to transmit and/or receive information without direct human interaction. For instance, a UE may be designed to transmit information to the access network on a predetermined schedule, when triggered by an internal or external event, or in response to requests from the access network. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub communicates with the access network to facilitate indirect communication between one or more UEs and network nodes. In some examples, the hub may be a controller, router, content source and analytics, or any of the other communication devices described herein regarding UEs. For example, the hub may be a broadband router enabling access to the core network for the UEs. As another example, the hub may be a controller that sends commands or instructions to one or more actuators in the UEs. Commands or instructions may be received from the UEs, network nodes, or by executable code, script, process, or other instructions in the hub. As another example, the hub may be a data collector that acts as temporary storage for UE data and, in some embodiments, may perform analysis or other processing of the data. As another example, the hub may be a content source. For example, for a UE that is a VR headset, display, loudspeaker or other media delivery device, the hub may retrieve VR assets, video, audio, or other media or data related to sensory information via a network node, which the hub then provides to the UE either directly, after performing local processing, and/or after adding additional local content. In still another example, the hub acts as a proxy server or orchestrator for the UEs, in particular if one or more of the UEs are low energy IoT devices.

The hub may have a constant/persistent or intermittent connection to the network node. The hub may also allow for a different communication scheme and/or schedule between the hub and UEs, and between the hub and the core network. In other examples, the hub is connected to the core network and/or one or more UEs via a wired connection. Moreover, the hub may be configured to connect to an M2M service provider over the access network and/or to another UE over a direct connection. In some scenarios, UEs may establish a wireless connection with the network nodes while still connected via the hub via a wired or wireless connection. In some embodiments, the hub may be a dedicated hub—that is, a hub whose primary function is to route communications to/from the UEs from/to the network node. In other embodiments, the hub may be a non-dedicated hub—that is, a device which is capable of operating to route communications between the UEs and network node, but which is additionally capable of operating as a communication start and/or end point for certain data channels.

As used herein, an example UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D 2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE includes processing circuitry that is operatively coupled via a bus to an input/output interface, a power source, a memory, a communication interface, and/or any other component, or any combination thereof. Certain UEs may utilize all or a subset of these components. The level of integration between the components may vary from one UE to another UE. Further, certain UEs may contain multiple instances of a component, such as multiple processors, memories, transceivers, transmitters, receivers, etc.

The processing circuitry is configured to process instructions and data and may be configured to implement any sequential state machine operative to execute instructions stored as machine-readable computer programs in the memory. The processing circuitry may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry may include multiple central processing units (CPUs).

In the example, the input/output interface may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source is structured as a battery or battery pack. Other types of power sources, such as an external power source (e.g., an electricity outlet), photovoltaic device, or power cell, may be used. The power source may further include power circuitry for delivering power from the power source itself, and/or an external power source, to the various parts of the UE via input circuitry or an interface such as an electrical power cable. Delivering power may be, for example, for charging of the power source. Power circuitry may perform any formatting, converting, or other modification to the power from the power source to make the power suitable for the respective components of the UE to which power is supplied.

The memory may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory includes one or more application programs, such as an operating system, web browser application, a widget, gadget engine, or other application, and corresponding data. The memory may store, for use by the UE, any of a variety of various operating systems or combinations of operating systems.

The memory may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory may allow the UE to access instructions, application programs and the like, stored on transitory or non-transitory memory media, to off-load data, or to upload data. An article of manufacture, such as one utilizing a communication system may be tangibly embodied as or in the memory, which may be or comprise a device-readable storage medium.

The processing circuitry may be configured to communicate with an access network or other network using the communication interface. The communication interface may comprise one or more communication subsystems and may include or be communicatively coupled to an antenna. The communication interface may include one or more transceivers used to communicate, such as by communicating with one or more remote transceivers of another device capable of wireless communication (e.g., another UE or a network node in an access network). Each transceiver may include a transmitter and/or a receiver appropriate to provide network communications (e.g., optical, electrical, frequency allocations, and so forth). Moreover, the transmitter and receiver may be coupled to one or more antennas and may share circuit components, software or firmware, or alternatively be implemented separately.

In some embodiments, communication functions of the communication interface may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

As used herein, an example network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, NodeBs, evolved NodeBs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node includes a processing circuitry, a memory, a communication interface, and a power source. The network node may be composed of multiple physically separate components (e.g., a NodeB component and a RNC component, or a BTS component and a BSC component, etc.), which may each have their own respective components. In certain scenarios in which the network node comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node may be configured to support multiple radio access technologies (RATs). In such embodiments, some components may be duplicated (e.g., separate memory for different RATs) and some components may be reused (e.g., a same antenna may be shared by different RATs). The network node may also include multiple sets of the various mentioned components for different wireless technologies integrated into network node, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node.

The processing circuitry may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node components, such as the memory, to provide network node functionality.

In some embodiments, the processing circuitry includes a system on a chip (SOC). In some embodiments, the processing circuitry includes one or more of radio frequency (RF) transceiver circuitry and baseband processing circuitry. In some embodiments, the radio frequency (RF) transceiver circuitry and the baseband processing circuitry may be on separate chips (or sets of chips), boards, or units, such as radio units and digital units. In alternative embodiments, part or all of RF transceiver circuitry and baseband processing circuitry may be on the same chip or set of chips, boards, or units.

The memory may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry. The memory may store any suitable instructions, data, or information, including a computer program, software, an application including one or more of logic, rules, code, tables, and/or other instructions capable of being executed by the processing circuitry and utilized by the network node. The memory may be used to store any calculations made by the processing circuitry and/or any data received via the communication interface. In some embodiments, the processing circuitry and memory is integrated.

The communication interface is used in wired or wireless communication of signaling and/or data between a network node, access network, and/or UE. The communication interface comprises port(s)/terminal(s) to send and receive data, for example to and from a network over a wired connection. The communication interface also includes radio front-end circuitry that may be coupled to, or in certain embodiments a part of, the antenna. Radio front-end circuitry comprises filters and amplifiers. The radio front-end circuitry may be connected to an antenna and processing circuitry. The radio front-end circuitry may be configured to condition signals communicated between antenna and processing circuitry. The radio front-end circuitry may receive digital data that is to be sent out to other network nodes or UEs via a wireless connection. The radio front-end circuitry may convert the digital data into a radio signal having the appropriate channel and bandwidth parameters using a combination of filters and/or amplifiers. The radio signal may then be transmitted via the antenna. Similarly, when receiving data, the antenna may collect radio signals which are then converted into digital data by the radio front-end circuitry. The digital data may be passed to the processing circuitry. In other embodiments, the communication interface may comprise different components and/or different combinations of components.

In certain alternative embodiments, the network node does not include separate radio front-end circuitry, instead, the processing circuitry includes radio front-end circuitry and is connected to the antenna. Similarly, in some embodiments, all or some of the RF transceiver circuitry is part of the communication interface. In still other embodiments, the communication interface includes one or more ports or terminals, the radio front-end circuitry, and the RF transceiver circuitry, as part of a radio unit, and the communication interface communicates with the baseband processing circuitry, which is part of a digital unit.

The antenna may include one or more antennas, or antenna arrays, configured to send and/or receive wireless signals. The antenna may be coupled to the radio front-end circuitry and may be any type of antenna capable of transmitting and receiving data and/or signals wirelessly. In certain embodiments, the antenna is separate from the network node and connectable to the network node through an interface or port.

The antenna, communication interface, and/or the processing circuitry may be configured to perform any receiving operations and/or certain obtaining operations described herein as being performed by the network node. Any information, data and/or signals may be received from a UE, another network node and/or any other network equipment. Similarly, the antenna, the communication interface, and/or the processing circuitry may be configured to perform any transmitting operations described herein as being performed by the network node. Any information, data and/or signals may be transmitted to a UE, another network node and/or any other network equipment.

The power source provides power to the various components of network node in a form suitable for the respective components (e.g., at a voltage and current level needed for each respective component). The power source may further comprise, or be coupled to, power management circuitry to supply the components of the network node with power for performing the functionality described herein. For example, the network node may be connectable to an external power source (e.g., the power grid, an electricity outlet) via an input circuitry or interface such as an electrical cable, whereby the external power source supplies power to power circuitry of the power source. As a further example, the power source may comprise a source of power in the form of a battery or battery pack which is connected to, or integrated in, power circuitry. The battery may provide backup power should the external power source fail. Embodiments of the network node may include additional components beyond those described above for providing certain aspects of the network node's functionality, including any of the functionality described herein and/or any functionality necessary to support the subject matter described herein. For example, the network node may include user interface equipment to allow input of information into the network node and to allow output of information from the network node. This may allow a user to perform diagnostic, maintenance, repair, and other administrative functions for the network node.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer—e.g. a single—unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1-50. (canceled)

51. A method for delay spread management, performed by a radio access node configured to communicate with a user device, the method comprising:
transmitting control signaling to the user device, wherein the control signaling is indicative of a configuration of the user device to perform delay spread measurements; and
receiving one or more delay spread reports from the user device in response to the configuration.

52. The method of claim 51, wherein the control signaling comprises radio resource control (RRC) signaling.

53. The method of claim 51, wherein the control signaling comprises a CSI-measConfig message.

54. The method of claim 51, wherein the control signaling comprises resource indication for the delay spread measurements and/or for the one or more delay spread reports.

55. The method of claim 51, wherein the control signaling comprises a time domain threshold for controlling the one or more delay spread reports.

56. The method of claim 51, wherein the control signaling comprises a power threshold for controlling the delay spread measurements and/or the one or more delay spread reports.

57. The method of claim 51, wherein the control signaling comprises an indication to include signal component power values in the one or more delay spread reports.

58. The method of claim 51, wherein the one or more delay spread reports comprises one or more of: an overall delay spread indication, a respective delay indication for at least one signal component, and a respective power indication for at least one signal component.

59. The method of claim 51, wherein the one or more delay spread reports are comprised in uplink control information (UCI) signaling.

60. The method of claim 51, further comprising receiving a delay spread measurement capability indication from the user device prior to transmitting the control signaling.

61. The method of claim 51, further comprising, after transmitting the control signaling indicative of the configuration of the user device to perform delay spread measurements, transmitting a report request to the user device, wherein reception of at least one of the one or more delay spread reports is responsive to transmitting the report request.

62. The method of claim 61, wherein transmitting the report request is responsive to one or more of:
an indication that a relative speed between the radio access node and the user device is higher than a speed threshold;
an indication that a frequency offset due to Doppler shift between the radio access node and the user device is higher than a frequency offset threshold; and
an indication that a signal-to-interference ratio (SIR) is lower than a SIR threshold.

63. The method of claim 51, further comprising, after transmitting the control signaling indicative of the configuration of the user device to perform delay spread measurements, receiving a reference signal request from the user device and transmitting reference signaling accordingly, wherein reception of at least one of the one or more delay spread reports is responsive to transmitting the reference signaling.

64. The method of claim 51, wherein transmitting the control signaling indicative of the configuration of the user device to perform delay spread measurements is responsive to one or more of:
an indication that a relative speed between the radio access node and the user device is higher than a speed threshold;
an indication that a frequency offset due to Doppler shift between the radio access node and the user device is higher than a frequency offset threshold; and
an indication that a signal-to-interference ratio (SIR) is lower than a SIR threshold.

65. The method of claim 51, further comprising avoiding to schedule transmission on communication resources within a specified time after transmission of reference signaling for delay spread measurements.

66. The method of claim 65, wherein the specified time is an expected delay spread and/or is indicated by the user device.

67. The method of claim 51, further comprising avoiding to schedule a second transmission for the user device on communication resources within a particular time after a first transmission for the user device.

68. The method of claim 67, wherein the particular time corresponds to the delay spread of the user device.

69. A method for delay spread management, performed by a user device configured to communicate with a radio access node, the method comprising:
performing delay spread measurements according to a configuration indicated by control signaling received from the radio access node; and
transmitting one or more delay spread reports indicative of a result of the delay spread measurements to the radio access node.

70. An apparatus for delay spread management, for a radio access node configured to communicate with a user device, the apparatus comprising controlling circuitry configured to:
transmit control signaling to the user device, wherein the control signaling is indicative of a configuration of the user device to perform delay spread measurements; and
receive one or more delay spread reports from the user device in response to the configuration.
